(19) United States
(12) Patent Application Publication
(10) Pub. No.: US 2015/0043016 A1
(43) Pub. Date: Feb. 12, 2015

(54) Process And System for Creating And Delivering Banner Strip Messaging In Print Format Along The Shelf Edge In A Retail Establishment

(71) Applicant: Vestcom New Century LLC, New Century, KS (US)

(72) Inventors: David N. Randall, Little Rock, AR (US); James E. Garvic, Olathe, KS (US)

(21) Appl. No.: 14/454,447

(22) Filed: Aug. 7, 2014

Related U.S. Application Data
(60) Provisional application No. 61/863,245, filed on Aug. 7, 2013.

(51) Int. Cl. B42D 15/00; G06Q 10/08; G06K 15/02

(52) U.S. Cl. CPC B42D 15/00; G06K 15/024; G06Q 10/087
USPC 358/1.6; 283/79

(57) ABSTRACT

Systems and methods for creating and delivering banner strip messaging in print format along a shelf edge in a retails establishment are disclosed. A process for creating and delivering banner strip messaging in print format includes the steps of: (1) receiving message content data and planogram data for a plurality of products from an input device, wherein the message content data includes price data and advertising data; (2) storing the message content data and the planogram data in a database; (3) aligning the message content data and the planogram data for each of the plurality of products; (4) creating a display template based on the aligned message content data and the planogram data; and (5) sending the display template to an output device, wherein the output device produces an output display.

### CROSS-REFERENCE TO RELATED APPLICATIONS

This application claims priority to provisional patent application No. 61/863,245, filed Aug. 7, 2013, the disclosure of which is incorporated herein in its entirety by reference.

### BACKGROUND

Retailers currently utilize print messaging at the shelf edge as a way of communicating with shoppers. These messages include but are not limited to product pricing, promotional offers, product content, health and wellness, and advertising. These messages normally are developed for each individual item on the store shelves. Messaging in the form of individual tags is often updated weekly as item price files are modified. Marketing and advertising messaging are usually modified less frequently as many offers last for several weeks, or as inventory levels dictate. The ability to provide a high quality color print message attached to the store shelf has been difficult to execute due to limited space availability, interference with product placement on the shelves, the physical nature of the shelf edge, the cost of installation and maintenance, and the constant contact with shoppers and store employees.

Printed tags and strips attached to the store shelves have continued to be the primary shopper communication medium in the aisles. Electronic communications networks have been attempted, but the cost to install and maintain have limited broad adoption. In most cases, the center of a grocery store does not have power outlets available to meet these electronic system requirements. Another factor is the fee structure required to offset the cost of these networks. The pricing for electronic media cannot compete with the printed tag, strip, or print signage within the store.

### SUMMARY

The following present a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented below.

In one embodiment, a duplex printed label sheet is disclosed, which includes a first printed label having an upper portion and a lower portion separated by a perforated line. A front side of the first printed label includes product specific information and a back side of the first printed label includes location data for placement of the first printed label along a shelf edge. In use, the upper portion is installed along the shelf edge and the lower portion hangs below the shelf edge when the first printed label is folded along the perforated line.

In another embodiment, a process for creating and delivering banner strip messaging in print format includes: (1) receiving message content data and planogram data for a plurality of products from an input device, wherein the message content data includes price data and advertising data; (2) storing the message content data and the planogram data in a database; (3) aligning the message content data and the planogram data for each of the plurality of products; (4) creating a display template based on the aligned message content data and the planogram data; and (5) sending the display template to an output device, wherein the output device produces an output display.

In yet another embodiment, a system for creating banner strip messaging in a print format has a server having a communication device, a processor, non-transitory computer memory having at least one program, and a database for storing planogram data and message content data; an input device having a communication device for providing the planogram data and the message content data; and an output device having a communication device for receiving information from the program and providing an output display. The program accesses the planogram data and the message content data received from the input device and stored in the database, aligns the correct message content data with the planogram data for a particular product, prepares an output template, and transmits the output template to the output device. The output template includes at least one label having an upper portion and a lower portion.

### BRIEF DESCRIPTION OF THE DRAWINGS

Illustrative embodiments of the present invention are described in detail below with reference to the attached figures.

FIG. 1 is a front view of a banner strip according to one embodiment.

FIG. 2 is a side view of a shelf indicating the position of the banner strip of FIG. 1 along a shelf edge.

FIG. 3 perspective view of a shelf having the banner strip of FIG. 1 positioned along the shelf edge corresponding to various product.

FIG. 4 is a block diagram of a system for creating and delivering banner strip messaging in print format.

FIG. 5 is a flowchart of an exemplary set of steps performed in one embodiment of the present method.

FIG. 6 shows an exemplary printed label sheet having multiple banner strips per sheet.

### DETAILED DESCRIPTION

Embodiments of the present invention include processes and systems for creating and implementing a banner strip print messaging network in a retail establishment.

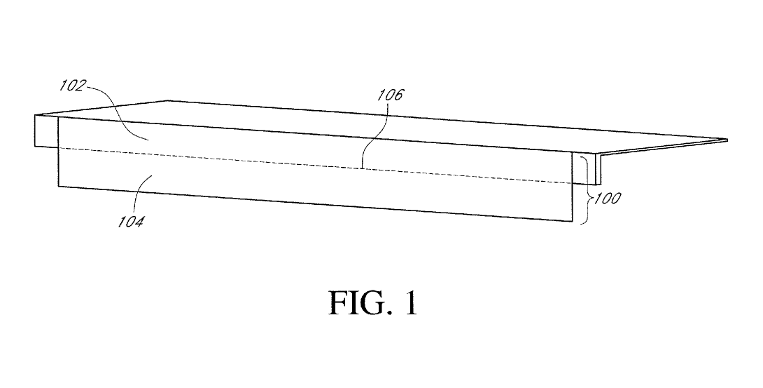

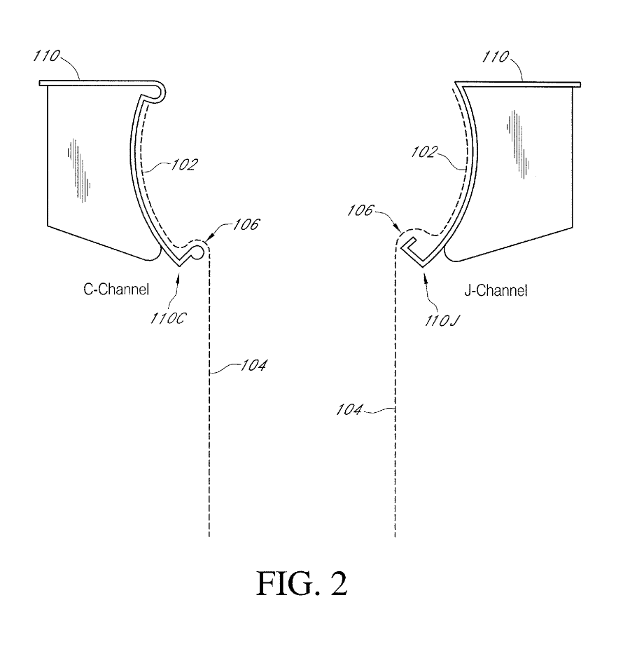

With reference to FIG. 1, a shelf tag (or “banner strip”) 100 may have an upper portion 102 and a lower portion 104 separated by a perforated line 106. The upper portion 102 may be designed to fit inside a shelf edge 110, such as a C-channel shelf edge (110C) or J-channel shelf edge (110J), as illustrated in FIG. 2. The perforated line 106 may aid in folding the lower portion 104 over the shelf edge 110 such that the lower portion 104 extends downward from the shelf edge 110.

The banner strip's upper portion 102 may include information relating to the price of an item stored at a particular location on the shelf 110. The lower portion 104 may include marketing or advertising information, promotional offers, product content, and health and wellness information, for example. Additionally, as the banner strips 100 may be duplex printed, additional information can be stored on the underside of the lower portion 104, including UPC numbers for the associated items, planogram numbers, aisle location data, chain/banner/store numbers, version, expiration dates, or other product specific data.

The information printed on the upper portion 102, the lower portion 104, and the underside of the lower portion 104 will hereinafter be generally referred to as message content data 425.

The banner strips 100 may be designed to meet the physical dimensions of the store shelf edge 110. The width of the upper portion 102 may be adjusted to correspond to the fixture measurements of a given store. A typical configuration includes, for example, 1⅜″, although the strip 100 may be any width. Additionally, the length of the banner strips 100 may vary to meet store shelving dimensions. Typical configurations include, for example, 3-foot and 4-foot long sections.

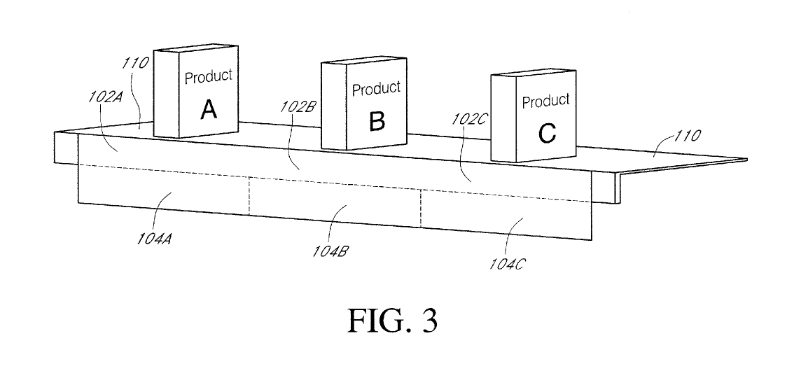

As shown in FIG. 3, the content of each banner strip 100 must align to each product position on the shelves 110 on each aisle. In FIG. 3, the upper portion 102A and lower portion 104A align with Product A on the shelf 110. Similarly, upper portions 102B, 102C and lower portions 104B, 104C align with Products B and C on the shelf 110, respectively.

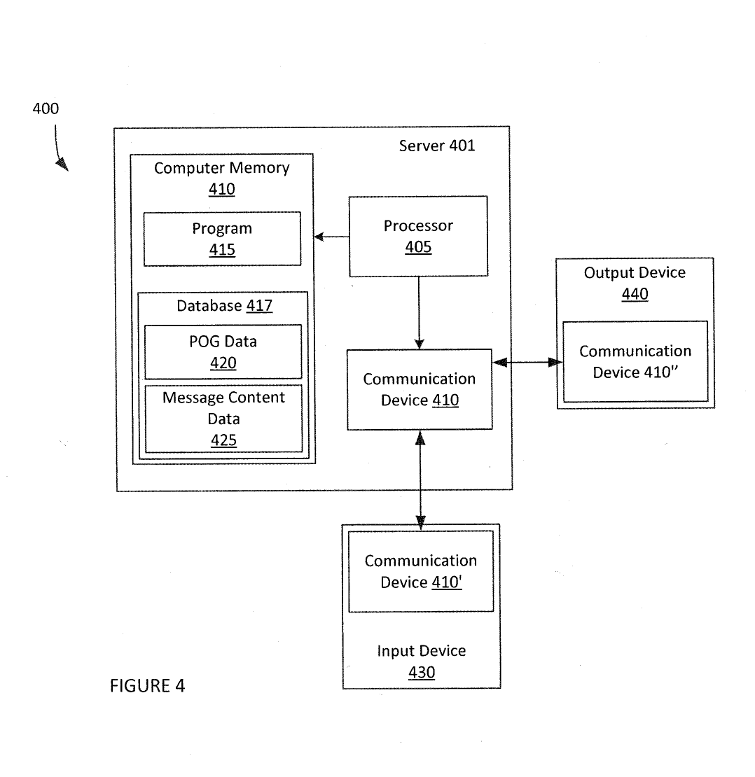

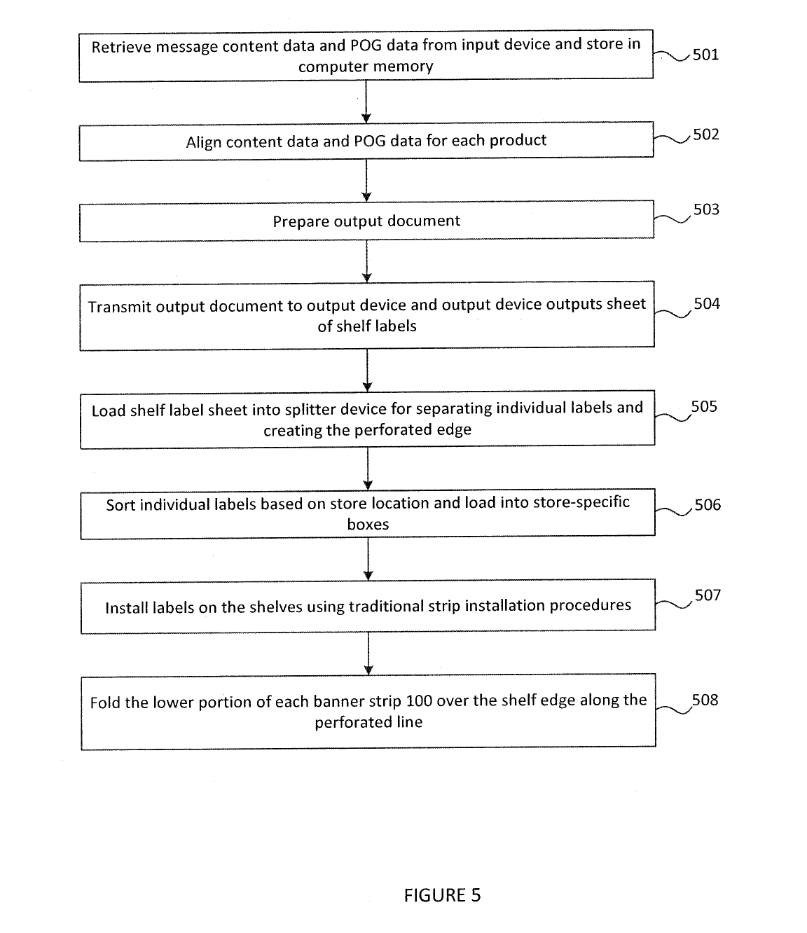

FIGS. 4-5 illustrate a system and method for creating, delivering, and installing banner strip messaging in print format that corresponds to the correct position of products on the shelves 110. The system 400 may include a server 401, at least one input device 430, and at least one output device 440.

In the embodiment 400, the server 401 includes a processor 405, which may be a single processor or multiple processors in communication with one another, in data communication with various elements. As shown in FIG. 4, the processor 405 is in data communication with computer memory 410. The memory 410 may support a program 415, and at least one database 417 for storing relevant product and product placement information, such as POG data 420 and message content data 425.

As will be appreciated by those skilled in the art, the computer memory 410 may consist of any appropriate computer-storage media (e.g., RMA, ROM, EEPROM, flash memory, et cetera) and the database 417 may be any electronic file or combination of files in which data is stored for use by the processor 405. The database 417 may additionally be split into additional databases. The program 415 is described in further detail below, with specific reference to FIG. 5.

A communication device 410 may be data communication with the processor 405 to communicate with an input device communication device 410′ and an output device communication device 410″. The communication devices 410, 410′, 410″ may utilize any appropriate communication technology whether now known or later developed.

The input device 430 (e.g., one or more keyboard, microphone, electronic-indicia reader, barcode scanner, et cetera) may be in data communication with the processor 405 to provide data from a particular store to the server 401, and the output device 440 (e.g., printer) may be in data communication with the processor 405 for providing a means for displaying product information to the particular store. The input device 430 may be a third party input device, or it may be an input device from a participating retailer.

In general terms, the programming 415 causes the processor 405 to undertake various steps for producing banner strips 100. Those skilled in the art will appreciate that the steps discussed herein may be caused by the programming 415, and that the exact location of the programming 415 and where the electronic data is maintained or processed is not critical.

As illustrated in FIG. 5, the process 500 begins at step 501, where the programming 415 causes the processor 405 to retrieve message content data 425 and planogram (or “POG”) data 420 from the input device 430 and store the data 420, 425 in the computer memory 410. Alternately, the message content data 425 and the POG data 420 may be stored directed in the computer memory 410, such that the processor 405 accesses the message content data 425 and the POG data 420 stored in the database 417 at step 501. As noted above, the message content data 425 may include price information relating to each product, as well as advertising and/or promotional content relating to each product.

The message content on each banner strip 100 must be aligned with the product position on the shelves in each aisle. Thus, at step 502, the program 415 aligns the correct message content data 425 with the POG data 420 using matching techniques for each product, and the process moves to step 503.

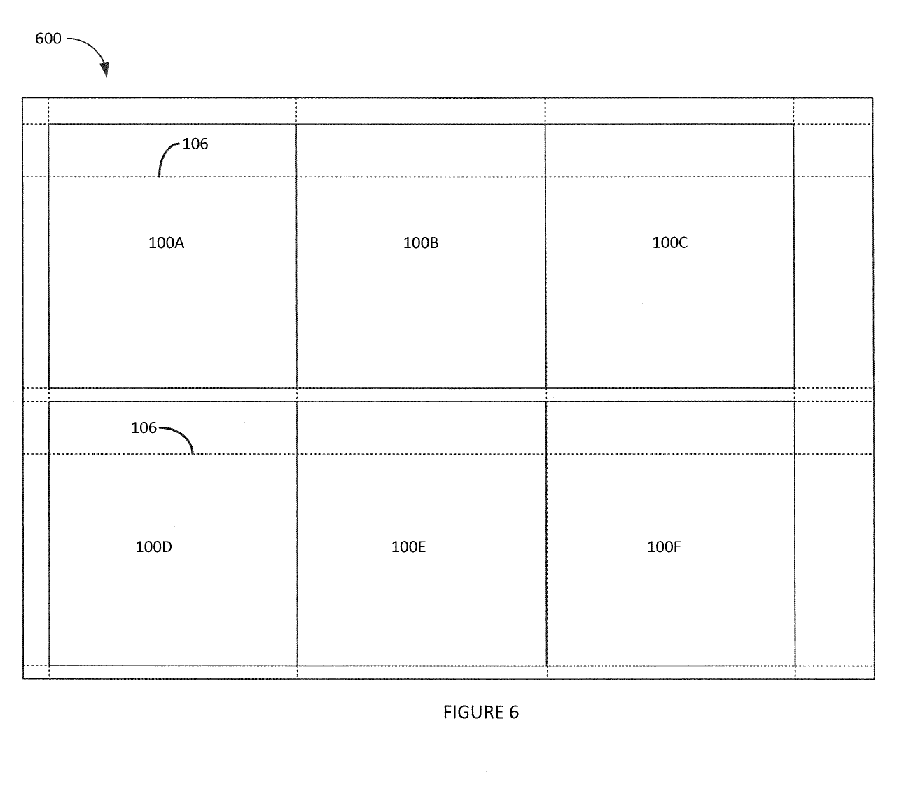

At step 503, the program 415 prepares an output document template (e.g., as illustrated at FIG. 6) based on the aligned message content data 425 and POG data 420. Each output document template may include several banner strips 100A-100F to be printed on a single page.

Moving on, at step 504, the output document template is transmitted to the output device 440, which may provide the appropriate output 600, such as a printed sheet having the desired content. As previously noted, the printed sheet 600 may be duplex printed, and therefore message content data 425 and/or POG data 420 may be printed on both sides of the printed sheet 600 as desired. It shall be noted that the output device 440 may be separate from the input device 430, or the input device 430 and the output device 440 may be combined into a single device. The process then moves to step 505.

At step 505, the printed sheet 600 may be loaded into a splitter device to complete a splitting process. As the printed sheet passes through the splitter device, the sheet may be separated into individual banner strips 100A-100F, as illustrated in FIG. 6 by broken lines. Alternately, the strips, for example strips 100A-100C in FIG. 6, may remain attached to form a long strip. Additionally, during step 505, the splitter device may create the perforated line 106.

The splitter device may be provided with the necessary die cutter specifications for each printed sheet. The splitter device may be a separate device, or it may be combined with the output device 440.

Moving on, at step 506, the banner strips 100 may be sorted based on location of the product and loaded into store specific boxes. For example, the banner strips 100 may be sorted in walk sequence order for ease of application. During a walk-sequenced installation process, banner strips 100 may be placed on the appropriate shelf location as indicated on the duplex printed information provided on the back side of the lower portion 104 of the strip 100. Additional store material may be loaded into the boxes prior to sealing the box for shipping. These additional materials may include, for example, price tags, advertising, promotion, marketing message tags, planogram information, store signage, and specific store instructions or directions.

At step 507, once the strips are received at a retail store, the banner strips 100 may be placed at the correct shelf location as described above, and as shown in FIG. 3. procedures. The lower portion 104 of the banner strips 100 may be folded over the shelf edge 110 along the perforated line 106 created during the die casting process (step 505). The lower portion 104 of the banner strips 100 may thus hang straight down from the shelf edge, as illustrated in FIG. 2.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A duplex printed label sheet, comprising:
a first printed label having an upper portion and a lower portion separated by a perforated line;
wherein:
a front side of the first printed label includes product specific information;
a back side of the first printed label includes location data for placement of the first printed label along a shelf edge; and
in use, the upper portion is installed along the shelf edge and the lower portion hangs below the shelf edge when the first printed label is folded along the perforated line.

2. The duplex printed label sheet of claim 1, further comprising a second printed label adjacent the first printed label, wherein a front side of the second printed label includes product specific information and a back side of the second printed label includes location data for placement of the first printed label and the second printed label.

3. The duplex printed label sheet of claim 2, wherein the product specific information includes at least one of price information, advertising information, promotional offers, product content, and health and wellness information.

4. The duplex printed label sheet of claim 3, wherein the first and second printed labels are separated from the printed label sheet for installation along the shelf edge at a retail establishment.

5. A process for creating and delivering banner strip messaging in print format, comprising:
receiving message content data and planogram data for a plurality of products from an input device, wherein the message content data includes price data and advertising data;
storing the message content data and the planogram data in a database;
aligning the message content data and the planogram data for each of the plurality of products;
creating a display template based on the aligned message content data and the planogram data; and
sending the display template to an output device, wherein the output device produces an output display.

6. The method of claim 5, wherein the output device is a printer and the output display is a printed label sheet.

7. The method of claim 6, wherein the printed label sheet includes at least one label having an upper portion and a lower portion separated by a perforated line.

8. The method of claim 7, wherein the printed label sheet is duplex printed and wherein the message content data is printed on a front side of the printed label sheet and the planogram data is printed on a back side of the printed label sheet.

9. The method of claim 8, wherein the message content data includes price information and at least one of advertising information, promotional information, product content, and health and wellness information.

10. The method of claim 9, wherein the price information is printed on the label upper portion, the advertising information, promotional information, product content, and/or health and wellness information is printed on the label lower portion.

11. The method of claim 8, further comprising the step of loading the printed label sheet into a splitter device, wherein the splitter device creates the perforated line between the label upper portion and the label lower portion.

12. The method of claim 11, wherein the splitter device further separates the labels from the printed label sheet.

13. The method of claim 12, further comprising the steps of:
sorting the labels based on location within a particular retail environment;
loading the labels into store-specific boxes;
shipping the boxes to the appropriate store; and
installing the labels on the shelves.

14. The method claim 13, wherein the step of installing the labels on the shelves further includes the steps of:
locating the appropriate shelf location based on the planogram data printed on the back side of the label;
installing the label upper portion onto a shelf edge; and
folding the label lower portion along the perforated line such that the label lower portion hangs straight down from the shelf edge.

15. A system for creating banner strip messaging in a print format, comprising:
a server having a communication device, a processor, non-transitory computer memory having at least one program, and a database for storing planogram data and message content data;
an input device having a communication device for providing the planogram data and the message content data; and
an output device having a communication device for receiving information from the program and providing an output display;
wherein the program accesses the planogram data and the message content data received from the input device and stored in the database, aligns the correct message content data with the planogram data for a particular product, prepares an output template, and transmits the output template to the output device; and
wherein the output template includes at least one label having an upper portion and a lower portion.

16. The system of claim 15, wherein the output device is a printer and the output display is a duplex printed label, and wherein the upper portion of printed label and the lower portion of the printed label are separated by a perforated line.

17. The system of claim 16, wherein the message content data includes price information and at least one of advertising information, promotional information, product content, and health and wellness information.

18. The system of claim 17, wherein the message content data is printed on a first side of the label and the planogram data is printed on a second side of the label.
